(19) United States
(12) Patent Application Publication
(10) Pub. No.: US 2005/0159517 A1
(43) Pub. Date: Jul. 21, 2005

(54) Stabilized thermoplastic compositions

(75) Inventors: Holger Warth, Dormagen (DE); Juan Gonzalez-Blanco, Koln (DE); Bodo Weickert, Leichlingen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/013,749

(22) Filed: Dec. 16, 2004

(30) Foreign Application Priority Data
Dec. 22, 2003 (DE) 10360367.0

(51) Int. Cl. C08K 5/15; C08K 5/34; C08K 5/49

(52) U.S. Cl. 524/111; 524/115

(57) ABSTRACT

A thermoplastic molding composition having improved level of thermal stability is disclosed. The composition contains A) graft polymer of
B) a lactone of formula (I) 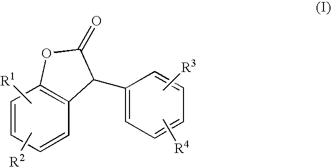 and C) at least one compound selected from the group consisting of
C.1) phosphorous acid esters of formula (II) 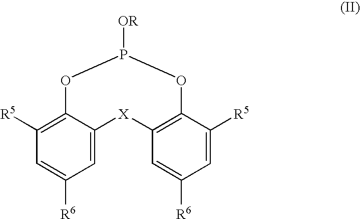
C.2 sterically hindered phenols of formula (III) 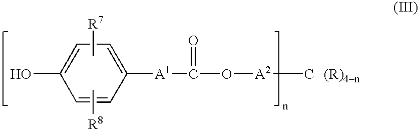
C.3 phosphites of formula (IV)

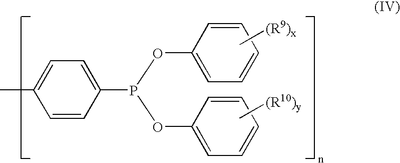

### FIELD OF THE INVENTION

The invention relates to a molding composition and more particularly to thermoplastic molding composition containing a graft polymer.

### TECHNICAL BACKGROUND OF THE INVENTION

WO 01/16224 describes polycarbonate molding compositions provided with cyanoacrylic acid esters in combination with a phosphite stabilizer and optionally a sterically hindered phenol and/or lactone having improved protection against UV radiation and color stability with reduced coating formation during processing.

Phosphorous acid esters are added to polycarbonate and polyester molding compositions for the purpose of stabilization under thermal load, in particular to prevent discoloration properties during the production of the molding compositions by compounding and processing of the molding compositions to form thermoplastic molded articles (e.g. DE-A 2 140 207, DE-A 2 255 639, DE-A 2 615 341).

Phosphorous acid esters are added in particular to polyalkylene terephthalates which are exposed to thermal and/or oxidative loads or strong UV radiation, for the purpose of stabilization. The stabilization reduces the polymer degradation on tempering in hot air, with the result that properties that are important for practical application, such as, for example, strength and stretchability, decline at a lower rate than in the case of unstabilized molding compositions (DE-A 2 615 341).

Phosphorous acid esters may likewise be added to polymer blends of polyalkylene terephthalate and polycarbonate, which exhibit good strength and dimensional stability under heat, in order to permit improved lacquerability and lacquer adhesion (EP-A 0 373 465).

WO 00/49078 describes a mixture comprising vinylcyclohexane-based polymer/copolymer and a stabilizer system comprising lactone, sterically hindered phenol and a phosphite component. Optical data carriers produced therefrom exhibit improved thermostabilization and a lesser decline in molecular weight.

The object of the present invention is to reduce the residual monomer constituents, especially of butadiene, in graft polymers, such as, for example, ABS, or blends comprising graft polymers. This reduction is of great importance in the automotive sector in particular because of the increased demands made in respect of emissions.

### SUMMARY OF THE INVENTION

A thermoplastic molding composition having improved level of thermal stability is disclosed. The composition contains.
A) graft polymer of B) a lactone of formula (I) 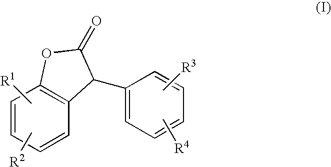
   and C) at least one compound selected from the group consisting of
C.1) phosphorous acid esters of formula (II) 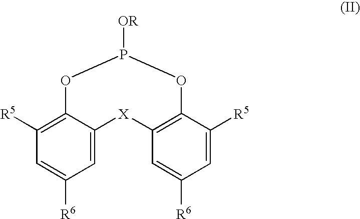
C.2 sterically hindered phenols of formula (III) 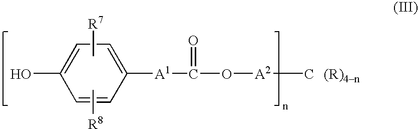
C.3 phosphites of formula (IV)

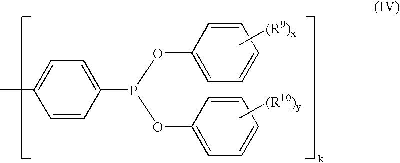

### DETAILED DESCRIPTION OF THE INVENTION

It has now been found that this object is achieved by the addition of a combination of one or more cyclic lactones with at least one compound selected from the group consisting of phosphorous acid esters, sterically hindered phenols and phosphates, particularly phosphorous acid esters to graft polymers and blends thereof with further thermoplastics. With this additive combination it is also possible under strict processing conditions to reduce the residual monomer contents in the composition and establish the limiting values desirable in the automotive industry, with an economic throughput.

The present invention accordingly provides compositions comprising
A) graft polymer of
A.1 from 5 to 95 wt. %, preferably from 8 to 90 wt. %, especially from 10 to 50 wt. %, of at least one vinyl monomer with
A.2 from 95 to 5 wt. %, preferably from 92 to 10 wt. %, especially from 90 to 50 wt. %, of one or more graft bases having glass transition temperatures <10° C., preferably <0° C., particularly preferably <−20° C., especially <−40° C.
B) a lactone of formula (I) 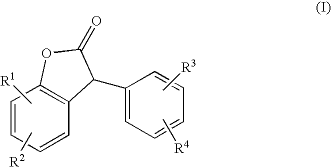
   in which
R¹, R², R³ and R⁴ independently represent hydrogen, C₁-C₆-alkyl, preferably C₁-C₄-alkyl, a 5- or 6-membered ring, preferably cyclohexyl or cyclopentyl. In a preferred embodiment R¹ and R² independently represent branched C₁-C₄-alkyl, especially isopropyl and/or tert.-butyl and R³ and R⁴ especially represent a methyl group, and optionally
C) at least one compound selected from the group consisting of
C.1) phosphorous acid esters of formula (II) 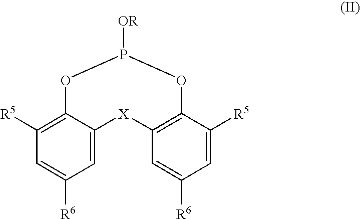
   wherein
R represents H or C₁-C₉-alkyl, C₅-C₆-cycloalkyl, C₇-C₉-aralkyl or C₆-C₁₀-aryl, and
R⁵ and R⁶ are identical or different and represent C₁-C₉-alkyl, C₅-C₆-cycloalkyl, C₇-C₉-aralkyl or C₆-C₁₀-aryl, and
X represents —S— or R¹¹—CH, wherein R¹¹ represents hydrogen, C₁-C₆-alkyl or C₅-C₆-cycloalkyl,
C.2 sterically hindered phenols of formula (III) 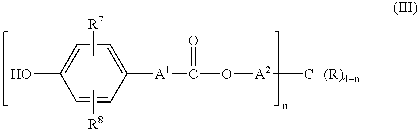
   in which
R⁷ and R⁸ each independently of the other represents hydrogen or C₁-C₆-alkyl, preferably C₁-C₄-alkyl, optionally a 5- or 6-membered ring, preferably cyclohexyl or cyclopentyl,
R⁷ and R⁸ each independently of the other particularly preferably represents C₃-C₄-alkyl, especially isopropyl and/or tert.-butyl,
n represents an integer from 1 to 4, preferably 3 or 4, especially 4,
A¹ and A² each independently of the other represents C₁-C₆-alkylene, preferably C₁-C₄-alkylene, especially methylene, ethylene,
R independently of any other(s) represents hydrogen, C₁-C₆-alkyl, preferably C₁-C₄-alkyl, C₁-C₆-alkoxy, preferably C₁-C₄-alkoxy, optionally a 5- or 6-membered ring, preferably cyclohexyl or cyclopentyl,
C.3 phosphites of formula (IV) 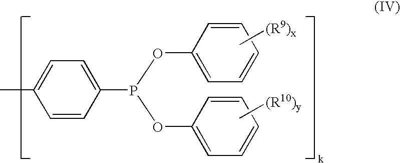
   in which
R⁹ and R¹⁰ each independently of the other represents hydrogen or C₁-C₆-alkyl, preferably C₁-C₄-alkyl, optionally a 5- or 6-membered ring, preferably cyclohexyl or cyclopentyl,
x and y each independently of the other represents 0, 1, 2, 3, 4, 5, preferably 0, 1 or 2, and
k represents 1 or 2,
R⁹ and R¹⁰ each independently of the other particularly preferably represents C₃-C₄-alkyl, especially isopropyl and/or tert.-butyl
   and optionally further components selected from at least one of the groups
D) polycarbonate and/or polyester carbonate
E) vinyl (co)polymer
F) flameproofing agents, especially phosphorus-based flameproofing agents
G) further additives.

Component B) is preferably used in amounts of from 0.01 to 2 wt. %, particularly preferably from 0.02 to 1 wt. % and very particularly preferred from 0.04 to 0.5 wt. %, based on 100 parts by weight of the composition as a whole.

Component C) is preferably added in amounts of from 0.01 to 2 wt. %, preferably from 0.02 to 1 wt. %, particularly preferably from 0.04 to 0.5 part by weight (based on 100 parts by weight of the composition as a whole).

The weight ratio of B):C) is particularly preferably 1:2.5.

Preferred compositions comprise
A) from 2 to 50 parts by weight, preferably from 3 to 45 parts by weight, especially from 4 to 30 parts by weight, of graft polymer of component A)
B) from 0.01 to 1 part by weight, preferably from 0.02 to 0.5 part by weight, particularly preferably from 0.04 to 0.2 part by weight, of lactone of formula (1)
C) from 0.01 to 2 parts by weight, preferably from 0.01 to 1 part by weight, particularly preferably from 0.03 to 0.5 part by weight, of phosphorous acid ester of formula (II)
D) from 20 to 98 parts by weight, preferably from 25 to 97 parts by weight, especially from 30 to 93 parts by weight, very particularly preferably from 60 to 93 parts by weight, of poly(ester) carbonate
B) from 0 to 40 parts by weight, preferably from 0 to 35 parts by weight, especially from 2 to 25 parts by weight, of vinyl (co)polymer
F) from 0 to 20 parts by weight, preferably from 2 to 18 parts by weight, of flameproofing agent as described below
G) from 0 to 2 parts by weight, preferably from 0.1 to 1 part by weight, especially from 0.2 to 0.7 part by weight, of antidripping agent, especially fluorinated polyolefin.
   Component A

The composition according to the invention comprises one or more graft polymers according to component A.
A.1 is preferably a mixture of
A.1.1 from 50 to 99 wt. % of at least one monomer selected from the group consisting of vinyl aromatic compounds. The vinyl aromatic compounds that may be ring-substituted include, for example, styrene, α-methylstyrene, p-methylstyrene, p-chlorostyrene, and methacrylic acid (C₁-C₈)-alkyl esters (such as methyl methacrylate, ethyl methacrylate) and
A.1.2 from 1 to 50 wt. % of at least one monomer selected from the group consisting of vinyl cyanides (unsaturated nitriles such as acrylonitrile and methacrylonitrile) and/or (meth)acrylic acid (C₁-C₈)-alkyl esters (such as methyl methacrylate, n-butyl acrylate, tert.-butyl acrylate) and/or derivatives (such as anhydrides and imides) of unsaturated carboxylic acids (for example maleic anhydride and N-phenyl-maleimide).

Preferred monomers A.1.1 are selected from the group consisting of styrene, α-methylstyrene and methyl methacrylate, and preferred monomers A.1.2 are selected from the group consisting of acrylonitrile, maleic anhydride and methyl methacrylate.

Particularly preferred monomer of A.1.1 is styrene and of A.1.2 is acrylonitrile.

Suitable graft bases A.2 for the graft polymers A are, for example, diene rubbers, EP(D)M rubbers, that is to say those based on ethylene/propylene and optionally diene, acrylate, polyurethane, silicone, chloroprene and ethylene/vinyl acetate rubbers. Also suitable as the graft base are mixtures of various of the mentioned rubbers.

Preferred graft bases A.2 are diene rubbers (e.g. based on butadiene, isoprene) or rubbers bared on mixtures of dienes with further copolymerizable monomers (e.g. according to A.1.1 and A.1.2), with the proviso that the glass transition temperature of component A.2 is below <10° C., preferably <0° C., particularly preferably <−20° C., especially <−40° C. Particular preference is given to pure polybutadiene rubber or butadiene/styrene copolymer having up to 50 wt. %, preferably 40 wt. %, especially 30 wt. % (based on the graft base) styrene.

Suitable acrylate rubbers according to A.2 of the polymers A are preferably polymers of acrylic acid alkyl esters, optionally with up to 40 wt. %, based on the graft base, of other polymerizable, ethylenically unsaturated monomers. The preferred polymerizable acrylic acid esters include C₁- to C₈-alkyl esters, for example methyl, ethyl, butyl, n-octyl and 2-ethylhexyl ester, as well as mixtures of these monomers.

Particularly preferred monomers A are, for example, ABS polymers (emulsion, mass and suspension ABS), as described, for example, in DE-A 2 035 390 (=U.S. Pat. No. 3,644,574) or in DE-A 2 248 242 (=GB-PS 1 409 275) or in Ullmanns, Enzyklopädie der Technischen Chemie, Vol. 19 (1980), p. 280 ff.

The gel content of the graft base A.2 is generally at least 30 wt. %, preferably at least 40 wt. % (measured in toluene).

The graft base A.2 generally has a median particle size (d₅₀ value) of from 0.05 to 10 μm, preferably from 0.1 to 5 μm, particularly preferably from 0.1 to 1 μm, especially from 0.2 to 0.5 μm.

The graft copolymers A are prepared by free-radical polymerization, for example by emulsion, suspension, solution or mass polymerization, preferably by emulsion polymerization (see e.g. DE-A 10 234 419).

Particularly suitable graft rubbers are also. ABS polymers prepared by redox initiation using an initiator system comprising organic hydroperoxide and ascorbic acid according to U.S. Pat. No. 4,937,285.

For crosslinking, monomers having more than one polymerizable double bond can be copolymerized. Preferred examples of crosslinking monomers are esters of unsaturated monocarboxylic acids having from 3 to 8 carbon atoms and of unsaturated monohydric alcohols having from 3 to 12 carbon atoms, or of saturated polyols having from 2 to 4 OH groups and from 2 to 20 carbon atoms, such as ethylene glycol dimethacrylate, allyl methacrylate; polyunsaturated heterocyclic compounds, such as trivinyl and triallyl cyanurate; polyfunctional vinyl compounds, such as di- and tri-vinylbenzenes; as well as triallyl phosphate and diallyl phthalate.

Preferred crosslinking monomers are allyl methacrylate, ethylene glycol dimethacrylate, diallyl phthalate and heterocyclic compounds having at least three ethylenically unsaturated groups. Particularly preferred crosslinking monomers are the cyclic monomers triallyl cyanurate, triallyl isocyanurate, triacryloylhexahydro-s-triazine, triallylbenzenes. The amount of crosslinked monomers is preferably from 0.02 to 5 wt. %, especially from 0.05 to 2 wt. %, based on the graft base A.2.

Preferred “other” polymerizable, ethylenically unsaturated monomers which may optionally be used in addition to the acrylic acid esters for the preparation of the graft base A.2 are, for example, acrylonitrile, styrene, (X-methylstyrene, acrylamides, vinyl C₁-C₆-alkyl ethers, methyl methacrylate, butadiene. Preferred acrylate rubbers as graft base A.2 are emulsion polymers having a gel content of at least 60 wt. %.

Further suitable graft bases according to A.2 are silicone rubbers having graft-active sites, as are described in DE-A 3 704 657, DE-A 3 704 655, DE-A 3 631 540 and DE-A 3 631 539.

The gel content of the graft base A.2 is determined at 25° C. in a suitable solvent (M. Hoffmann, H. Krömer, R. Kuhn, Polymeranalytik I und II, Georg Thieme-Verlag, Stuttgart 1977).

The median particle diameter d₅₀ is the diameter above and below which in each case 50 wt. % of the particles lie. It may be determined by means of ultracentrifuge measurement (W. Scholtan, H. Lange, Kolloid, Z. und Z. Polymere 250 (1972), 782-1796).

Component B

Cyclic lactones of formula (I) are known (e.g. WO 00/49078), or may be prepared according to known processes, and are also available commercially. Particular preference is given to the lactone according to formula (I-1) 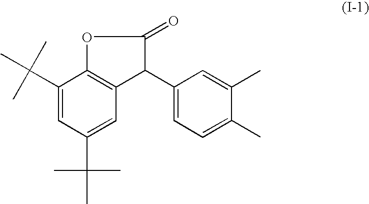
Component C

Where n=1 in compounds of formula (TV), the valence of the carbon atom in question is bonded with hydrogen or C₁-C₆-alkyl, C₁-C₆-alkoxy, optionally 5- or 6-membered ring, preferably C₁-C₄-alkyl, preferably with the radicals mentioned in R⁹ and R₁₀.

The indicated structural formulae show in each case the principal components (>90%) of the industrially used compounds, which may contain, for example, isomers, starting materials and subsidiary compounds in lesser amounts.

Preference is given to the use of phosphorous acid esters of formula (II) in which R⁵ and R⁶ represent a benzyl, α-methylbenzyl, α,α-dimethylbenzyl, methyl, ethyl, isopropyl, tert.-butyl, tert.-amyl, isononyl, cyclopentyl or cyclohexyl radical and X represents

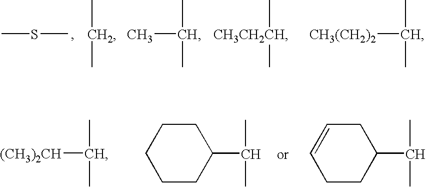

Particular preference is given to the phosphorous acid ester of formula (II-1), wherein X represents methylene, R⁵ represents cyclohexyl and R⁶ represents methyl[4,8-dicyclohexyl-6-hydroxy-2,10-dimethyl-12H-dibenzo-(d,g)(1,3,2)-dioxaphosphocine]

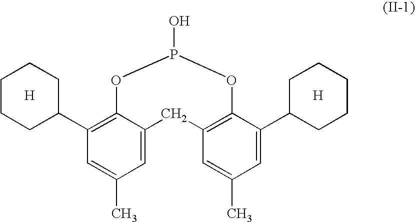

The phosphorous acid esters of formula (II) may be prepared in a known manner by reaction of triphenyl phosphite with corresponding dihydroxy compounds in the presence of water (see e.g. DE-A 29 29 229).

The formulae of compounds III-1, IV-1 and IV-2 are shown hereinbelow: 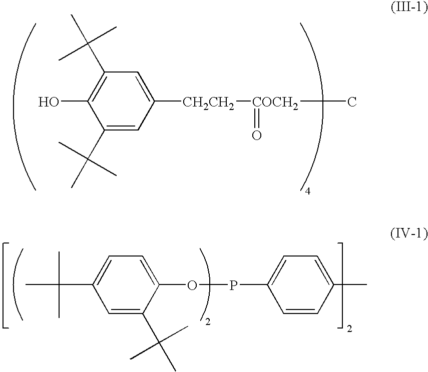
(obtainable under the commercial name Irgafos P EPO, Ciba Specialities) 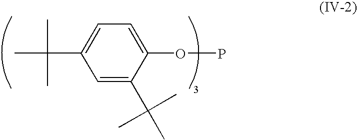
(obtainable under-the commercial name Irgafos 168, Ciba Specialities).

The sterically hindered phenols and phosphite compounds are generally known and are available commercially.

It is also possible to use a mixture of several compounds of component (C).

The composition may include further thermoplastics, such as, for example, polycarbonate (component D), vinyl (co)polymers (component E) and/or flameproofing agents F), especially phosphorus-based flameproofing agents that are different from compounds included in component C). Additives such as, for example, mold-release agent, stabilizers, etc. (component G) may likewise be added.

Component D

Aromatic polycarbonates and/or aromatic polyester carbonates that are suitable according to the invention are known in the literature or may be prepared by processes which are known in the literature (for the preparation of aromatic polycarbonates see, for example, Schnell, “Chemistry and Physics of Polycarbonates”, Interscience Publishers, 1964 (e.g. EP-A 640 655).

The preparation of aromatic polycarbonates is carried out, for example, by melt processes or by reaction of diphenols with carbonic acid halides, preferably phosgene, and/or with aromatic dicarboxylic acid dihalides, preferably benzenedicarboxylic acid dihalides, by the interfacial process, optionally with the use of chain terminators, for example monophenols, and optionally with the use of branching agents having a functionality of three or more, for example triphenols or tetraphenols.

Diphenols and dihydroxy compounds for the preparation of the aromatic polycarbonates and/or aromatic polyester carbonates are preferably those of formula (V) 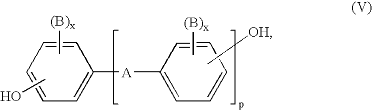
wherein
A is a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, to which there may be condensed further aromatic rings optionally containing hetero atoms,
   or a radical of formula (1) or (2) 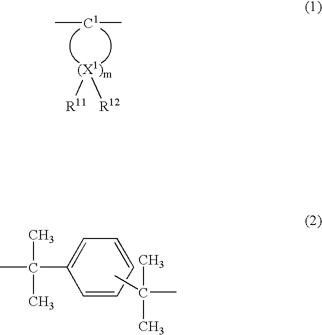
B is C₁- to C₁₂-alkyl, preferably methyl, halogen, preferably chlorine and/or bromine,
the substituents x are each independently of the other 0, 1 or 2,
p is 1 or 0, and
R¹¹ and R¹² can be chosen individually for each X¹ and are each independently of the other hydrogen or C₁- to C₆-alkyl, preferably hydrogen, methyl or ethyl,
X¹ is carbon and
m is an integer from 4 to 7, preferably 4 or 5, with the proviso that R¹¹ and R¹² are simultaneously alkyl on at least one atom X¹.

Preferred dihydroxy compounds are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl)ethers, bis-(hydroxyphenyl)sulfoxides, bis-(hydroxyphenyl)ketones, bis-(hydroxyphenyl)-sulfones and α,α-bis-(hydroxyphenyl)-diisopropyl-benzenes and their derivatives brominated and/or chlorinated on the ring.

Particularly preferred diphenols are 4,4′-dihydroxydiphenyl, bisphenol A, 2,4-bis-(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenylsulfone and their di- and tetra-brominated or—chlorinated derivatives, such as, for example, 2,2-bis-(3-chloro-4-hydroxyphenyl)-propane, 2,2-bis-(3,5-dichloro-4-hydroxyphenyl)-propane or 2,2-bis-(3,5-dibromo-4-hydroxyphenyl)propane. 2,2-Bis-(4-hydroxyphenyl)propane (bisphenol A) is particularly preferred.

The dihydroxy compounds may be used individually or in the form of any desired mixtures. The dihydroxy compounds are known and are obtainable by known processes. Suitable chain terminators and branching agents, if desired, are described in EP-A 640 655.

Both homopolycarbonates and copolycarbonates are suitable. For the preparation of copolycarbonates suitable as component A , it is also possible to use from 1 to 25 wt. %, preferably from 2.5 to 25 wt. % (based on the total amount of dihydroxy compounds used), of polydiorganosiloxanes having hydroxyaryloxy terminal groups. These are known (for example U.S. Pat. No. 3,419,634) or may be prepared by known processes. The preparation of copolycarbonates containing polydiorganosiloxanes is described, for example, in DE-A 3 334 782.

Preferred polycarbonates, in addition to the homopolycarbonates of bisphenol A, are the copolycarbonates of bisphenol A having up to 15 mol. %, based on the total molar amounts of dihydroxy compounds, of other dihydroxy compounds mentioned as being preferred or particularly preferred. Aromatic dicarboxylic acid dihalides for the preparation of aromatic polyester carbonates are preferably the diacid dichlorides of isophthalic acid, terephthalic acid, diphenyl ether 4,4′-dicarboxylic acid and naphthalene-2,6-dicarboxylic acid. Particular preference is given to mixtures of the diacid dichlorides of isophthalic acid and terephthalic acid in a ratio of from 1:20 to 20:1. In the preparation of polyester carbonates, a carbonic acid halide, preferably phosgene, is additionally used concomitantly as a bifunctional acid derivative. The aromatic polyester carbonates may also contain aromatic hydroxycarboxylic acids incorporated therein. The aromatic polyester carbonates may be either linear or branched in a known manner (see in this connection also DE-A 2 940 024 and DE-A 3 007 934).

The proportion of carbonate structural units in the thermoplastic aromatic polyester carbonates may vary as desired. The proportion of carbonate groups is preferably up to 100 mol. %, especially up to 80 mol. %, particularly preferably up to 50 mol. %, based on the total number of ester groups and carbonate groups. Both the ester component and the carbonate component of the aromatic polyester carbonates may be present in the polycondensation product in the form of blocks or in a randomly distributed manner.

The relative solution viscosity (ηᵣₑₗ) of the aromatic polycarbonates and polyester carbonates is in the range of from 1.18 to 1.4, preferably from 1.20 to 1.32 (measured on solutions of 0.5 g of polycarbonate or polyester carbonate in 100 ml of methylene chloride solution at 25° C.).

The thermoplastic aromatic polycarbonates and polyester carbonates may be used alone or in any desired mixture.

Component E

There may further be added as component E) one or more thermoplastic vinyl (co)polymers.

Suitable vinyl (co)polymers are polymers of at least one monomer from the group of the vinyl aromatic compounds, vinyl cyanides (unsaturated nitrites), (meth)acrylic acid (C₁ to C₈)-alkyl esters, unsaturated carboxylic acids and derivatives (such as anhydrides and imides) of unsaturated carboxylic acids. Particularly suitable are (co)polymers of
from 50 to 99 wt. %, preferably from 60 to 80 wt. %, vinyl aromatic compounds and/or vinyl aromatic compounds substituted on the ring (such as, for example, styrene, α-methylstyrene, p-methylstyrene, p-chlorostyrene) and/or methacrylic acid (C₁ to C₈)-alkyl esters (such as methyl methacrylate, ethyl methacrylate) and
from 1 to 50 wt. %, preferably from 20 to 40 wt. %, vinyl cyanides (unsaturated nitrites), such as acrylonitrile and methacrylonitrile, and/or (meth)acrylic acid (C₁-C₈)-alkyl esters (such as methyl methacrylate, n-butyl acrylate, tert.-butyl acrylate) and/or unsaturated carboxylic acids (such as maleic acid) and/or derivatives (such as anhydrides and imides) of unsaturated carboxylic acids (for example maleic anhydride and N-phenyl-maleimide).

The copolymer of styrene and acrylonitrile is particularly preferred.

The (co)polymers are resin-like and thermoplastic. The (co)polymers are known and may be prepared by free-radical polymerization, especially by emulsion, suspension, solution or mass polymerization. The (co)polymers preferably have mean molecular weights M_{w} (weight average, determined by light scattering or sedimentation) of from 15,000 to 200,000, especially from 50,000 to 180,000.

Component F

The compositions according to the invention, especially compositions comprising polycarbonate and graft polymer according to component A), may preferably comprise phosphorus-containing flameproofing agents that differ structurally from Component C). These are preferably selected from the groups of the monomeric and oligomeric phosphoric and phosphonic acid esters, phosphonate amines and phosphazenes, it also being possible to use as flameproofing agents mixtures of several components selected from one or various of these groups. Other halogen-free phosphorus compounds not mentioned specifically here may also be used alone or in any desired combination with other halogen-free phosphorus compounds.

Preferred monomeric and oligomeric phosphoric and phosphonic acid esters are phosphorus compounds of the general formula (VI) 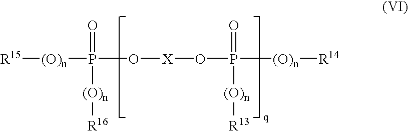
wherein
R¹³, R¹⁴, R¹⁵ and R¹⁶ each independently of the others represents optionally halogenated C₁- to C₈-alkyl, C₅- to C₆-cycloalkyl, C₆- to C₂₀-aryl or C₇- to C₁₂-aralkyl each optionally substituted by alkyl, preferably C₁-C₄-alkyl, and/or by halogen, preferably chlorine, bromine,
the substituents n each independently of the others represent 0 or 1;
q represents from 0 to 30, and
X represents a mono- or poly-nuclear aromatic radical having from 6 to 30 carbon atoms, or a linear or branched aliphatic radical having from 2 to 30 carbon atoms, which may be OH-substituted and may contain up to 8 ether bonds.
R¹³, R¹⁴, R¹⁵ and R¹⁶ each independently of the others preferably represents C₁-C₄-alkyl, phenyl, naphthyl or phenyl-C₁-C₄-alkyl. The aromatic groups R¹³, R¹⁴, R¹⁵ and R¹⁶ may in turn be substituted by halogen and/or alkyl groups, preferably chlorine, bromine and/or C₁-C₄-alkyl. Particularly preferred aryl radicals are cresyl, phenyl, xylenyl, propylphenyl or butylphenyl, as well as the corresponding brominated and chlorinated derivatives thereof.
X in formula (VI) preferably represents a mono- or poly-nuclear aromatic radical having from 6 to 30 carbon atoms. This radical is preferably derived from diphenols of formula (V).

The substituents n in formula (VI) may each independently of the others be 0 or 1; n is preferably equal to 1.
q represents number-averaged values of from 0 to 30. Preferably number-averaged q values of from 0.3 to 20, particularly preferably from 0.5 to 10, especially from 0.5 to 6, very particularly preferably from 0.7 to 1.4.
X particularly preferably represents 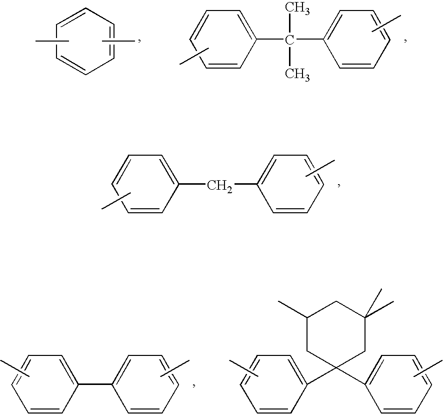
   or the chlorinated or brominated versions thereof; X is derived especially from resorcinol, hydroquinone, bisphenol A or diphenylphenol. X is derived particularly preferably from bisphenol A.

The phosphorus compounds according to formula (VI) are known (see e.g. EP-A 363 608, EP-A 640 655) or may be prepared by known methods in an analogous manner (e.g. Ullmanns Encyklopädie der technischen Chemie, Vol. 18, p. 301 ff 1979; Houben-Weyl, Methoden der organischen Chemie, Vol. 12/1, p. 43; Beilstein Vol. 6, p. 177).

The mean q values may be determined by determining the composition of the phosphate mixture (molecular weight distribution) by means of a suitable method (gas chromatography (GC), high pressure liquid chromatography (HPLC), gel permeation chromatography (GPC)) and calculating the mean values for q therefrom.

Component G

The flameproofing agents according to component F) are often used in combination with so-called antidripping agents, which reduce the tendency of the material to produce burning drips in case of fire. Compounds of the substance classes of the fluorinated polyolefins, the silicones and aramid fibers may be mentioned as examples in this connection. These may also be used in the compositions according to the invention. Fluorinated polyolefins are preferably used as antidripping agents.

Fluorinated polyolefins are known and are described, for example, in EP-A 0 640 655. They are marketed, for example, by DuPont under the trademark Teflon® 30N.

The fluorinated polyolefins may be used either in pure form or in the form of a coagulated mixture of emulsions of the fluorinated polyolefins with emulsions of the graft polymers (component A) or with an emulsion of a copolymer, preferably based on styrene/acrylonitrile or PMMA, the fluorinated polyolefin in the form of an emulsion being mixed with an emulsion of the graft polymer or of the copolymer and then being coagulated.

The fluorinated polyolefins may also be used in the form of a pre-compound with the graft polymer (component A) or a copolymer, preferably based on styrene/acrylonitrile or PMMA. The fluorinated polyolefins are mixed in the form of a powder with a powder or with granules of the graft polymer or copolymer and are compounded in the melt, generally at temperatures of from 200 to 330° C., in conventional devices such as internal kneaders, extruders or twin-shaft screws.

The fluorinated polyolefins may also be used in the form of a masterbatch, which is prepared by emulsion polymerization of at least one monoethylenically unsaturated monomer in the presence of an aqueous dispersion of the fluorinated polyolefin. Preferred monomer components are styrene, acrylonitrile, methyl methacrylate and mixtures thereof. After acid precipitation and subsequent drying, the polymer is used in the form of a pourable powder.

The coagulates, pre-compounds or masterbatches generally have fluorinated polyolefin solids contents of from 5 to 95 wt. %, preferably from 7 to 80 wt. %.

The fluorinated polyolefins are used in the amounts mentioned above, these amounts being based, in the case of the use of a coagulate, pre-compound or masterbatch, on the pure fluorinated polyolefin.

Further Additives

The compositions according to the invention may also include up to 10 parts by weight, preferably from 0.1 to 5 parts by weight, of at least one conventional polymer additive, such as a lubricant and mold-release agent, for example pentaerythritol tetrastearate, a nucleating agent, an antistatic, a stabilizer, a light stabilizer, a filler and reinforcing material, a coloring agent or pigment and also a further flameproofing agent or a flameproofing synergist, for example an inorganic substance in nanoscale form and/or a silicate-like material such as talc or wollastonite.

The parts by weight given in this application are to be so standardized that the sum of the parts by weight of all the components A) to G) is equal to 100.

The compositions according to the invention are prepared by mixing the respective constituents in a known manner and carrying out melt-compounding and melt-extrusion at temperatures of from 200° C. to 300° C. in conventional devices such as internal kneaders, extruders and twin-shaft screws.

Mixing of the individual constituents may be carried out in known manner either in succession or simultaneously, either at about 20° C. (room temperature) or at a higher temperature.

The compositions according to the invention may be used in the production of molded articles of any kind. These may be produced by injection molding, extrusion and blow-molding processes, for example. A further form of processing is the production of molded bodies by deep-drawing from previously produced sheets or films.

Examples of such molded articles are films, profiles, casing parts of any kind, for example for domestic appliances such as juice extractors, coffee machines, mixers; for office equipment such as monitors, printers, copiers; also sheets, tubes, conduits for electrical installations, profiles for the construction sector, interior finishing and external applications; parts from the field of electrical engineering, such as switches and plugs, as well as internal and external parts for motor vehicles.

The compositions according to the invention may be used in particular in the production of the following molded articles or moldings, for example:
parts for the interior finishing of railway vehicles, ships, aircraft, buses and cars, hub caps, casings for electrical equipment containing small transformers, casings for devices for distributing and transmitting information, casings and linings for medical purposes, massage devices and casings therefor, toy vehicles for children, flat wall elements, casings for security devices, rear spoilers, bodywork parts for motor vehicles, heat-insulated transport containers, device for keeping or caring for small animals, moldings for sanitary and bathroom fittings, cover grids for ventilator openings, moldings for summer houses and tool sheds, casings for garden equipment.

The Examples which follow serve to illustrate the invention further.

### EXAMPLES

The components indicated in Table 1 and discussed briefly hereinbelow are compounded in a ZSK-25 at different substance temperatures (see Table 1). The residual monomer values, especially the amount of butadiene, are then measured. These measurements are carried out both on the granules and on molded articles which have been produced on an Arburg 270 E injection-molding machine at the indicated temperatures (280/300° C.).

Component A (ABS)

Graft polymer of 40 parts by weight of a copolymer of styrene and acrylonitrile in a ratio of 73:27 with 60 parts by weight of particulate, crosslinked polybutadiene rubber (median particle diameter d₅₀=0.3 μm), prepared by emulsion polymerization.

Component B (I-1)

HP 136 from Ciba Speciality Chemicals, Basle, Switzerland (lactone of formula I-1, see hereinabove).

Component C (II-1)

Phosphorous acid ester of formula II-1 (see hereinabove).

Component D (PC)

Linear polycarbonate based on bisphenol A, having a relative solution viscosity of 1.24 measured in CH₂Cl₂ as solvent at 25° C. and a concentration of 0.5 g/100 ml.

Component E (SAN)

Styrene/acrylonitrile copolymer having a styrene/acrylonitrile ratio of 72:28 and an intrinsic viscosity of 0.55 dl/g (measurement in dimethylformamide at 20° C.).

Component G (PETS)

PETS=pentaerythritol tetrastearate

The residual monomer content is determined by means of GC/MS (gas chromatography/mass spectroscopy).

TABLE 1
Composition of the molding compositions and properties

| Components/amounts | 1 | | | |
|---|---|---|---|---|
| and parts by weight | (comp.) | 2 | 3 | 4 |
| PC | 70.0 | 70.0 | 70 | 70.0 |
| SAN | 17.0 | 17.0 | 17 | 17.0 |
| ABS | 13.0 | 13.0 | 13 | 13.0 |
| PETS | 0.75 | 0.75 | 0.75 | 0.75 |
| II-1 | 0.1 | 0.1 | — | — |
| I-1 | — | 0.06 | 0.06 | 0.09 |
| Residual monomer measured on | 1.7 | 1 | 1.1 | 0.9 |
| the test specimen (280° C. | | (−41%) | (−35%) | (−47%) |
| substance temperature during | | | | |
| injection molding): | | | | |
| butadiene (ppm) | | | | |
| Residual monomer measured on | 3.8 | 2.7 | 2.6 | 2.5 |
| the test specimen (300° C. | | (−29%) | (−32%) | (−34%) |
| substance temperature during | | | | |
| injection molding): | | | | |
| butadiene (ppm) | | | | |
| Residual monomer measured on | 1.2 | 0.8 | 1 | 0.7 |
| the granules (260° C. substance | | (−33%) | (−17%) | (−42%) |
| temperature during | | | | |
| compounding): | | | | |
| butadiene (ppm) | | | | |

In contrast to Comparison Example 1, a marked reduction in the residual monomer content is achieved with the other formulations. The residual monomer content of a comparison Example containing neither (I-1) nor (II-1) was slightly higher than that of comparison Example 1. The reduction is obtained both on the granules and in the case of subsequent further processing to molding compositions.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A thermoplastic molding composition comprising
A) graft polymer of
A.1 from 5 to 95 wt. % of at least one vinyl monomer with
A.2 from 95 to 5 wt. % of one or more graft bases having glass transition temperatures <10° C, the percents referring to the weight of the graft polymer
B) a lactone of formula (I) 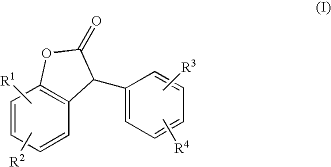
in which
R¹, R², R³ and R⁴ each independently of the others represents hydrogen, C₁-C₆-alkyl or a 5- or 6-membered ring, and optionally
C) at least one compound selected from the group consisting of
C.1) phosphorous acid esters of formula (II) 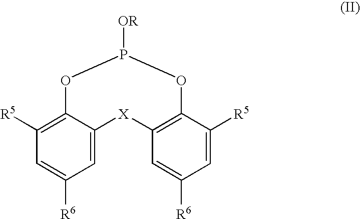
wherein
R represents H or C₁-C₉-alkyl, C₅-C₆-cycloalkyl, C₇-C₉-aralkyl or C₆-C₁₀-aryl, and
R⁵ and R⁶ are identical or different and represent C₁-C₉-alkyl, C₅-C₆-cycloalkyl, C₇-C₉-aralkyl or C₆-C₁₀-aryl, and
X represents —S— or R¹¹—CH, wherein R¹¹ represents hydrogen, C₁-C₆-alkyl or C₅-C₆-cycloalkyl,
C.2 sterically hindered phenols of formula (III) 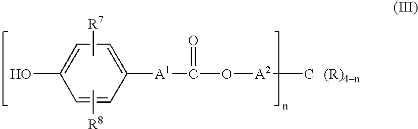
in which
R⁷ and R⁸ each independently of the other represents hydrogen, C₁-C₆-alkyl or a 5- or 6-membered ring,
n represents an integer from 1 to 4,
A¹ and A² each independently of the other represents C₁-C₆-alkylene,
R independently of any other(s) represents hydrogen, C₁-C₆-alkyl, C₁-C₆-alkoxy or a 5- or 6-membered ring;
C.3 phosphites of formula (IV) 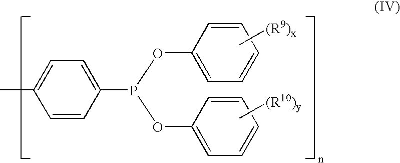
in which
R⁹ and R¹⁰ each independently of the other represents hydrogen or C₁-C₆-alkyl, optionally a 5- or 6-membered ring,
x and y each independently of the other represents 0, 1, 2, 3, 4, 5, and
n represents 1 or 2,
and optionally further components selected from the group consisting of D) polycarbonate and/or polyester carbonate
E) vinyl (co)polymer
F) flameproofing agents
G) functional additives.

2. The composition according to claim 1, wherein component B) is present in an amount of 0.01 to 2 wt. % relative to the total weight of the total composition.

3. The composition according to claim 1 wherein component C) is present in an amount of 0.01 to 2 wt. % relative to the total weight of the composition.

4. The composition according to claim 1 wherein A) is present in an amount of 2 to 50 parts by weight (pbw), B) is present in an amount of 0.01 to 1 pbw, C) in the form of formula (II) is present in an amount of 0.01 to 2 pbw, D) is present in an amount of 20 to 98 pbw, E) is present in an amount of 0 to 40 pbw, F) is present in an amount of 0 to 20 pbw and G) is present in an amount of 0 to 2 pbw in the form of an anti-dripping agent, based on 100 parts by weight of the composition as a whole.

5. The composition according to claim 1 wherein the graft polymer contains the polymerization product of
A.1.1 50 to 99 wt. % of at least one monomer selected from a first group consisting of vinyl aromatic compounds, ring-substituted vinyl aromatic compounds and methacrylic acid (C₁-C₈)-alkyl esters and
A.1.2 1 to 50 wt. % of at least one monomer selected from a second group consisting of vinyl cyanides, (meth)acrylic acid (C₁-C₈)-alkyl esters and derivatives of unsaturated carboxylic acids.

6. The composition according to claim 5, wherein said first group consists of styrene, (α-methylstyrene and methyl methacrylate, and where said second group consists of acrylonitrile, maleic anhydride and methyl methacrylate.

7. The composition according to claim 4, wherein the graft polymer A contains a graft base A.2, said graft base containing at least one member selected from the group consisting of diene rubber, EP(D)M rubber, acrylate, polyurethane, silicone, chloroprene and ethylene/vinyl acetate rubbers.

8. The composition according to claim 1 wherein lactone conforms structurally to

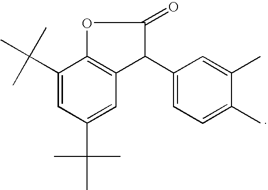

9. The composition according to claim 1 wherein formula (II) R⁵ and R⁶ represent a member selected from the group consisting of benzyl, α-methylbenzyl, α,α-dimethylbenzyl, methyl, ethyl, isopropyl, tert.-butyl, tert.-amyl, isononyl, cyclopentyl and cyclohexyl radical and X represents a member selected from the group consisting of

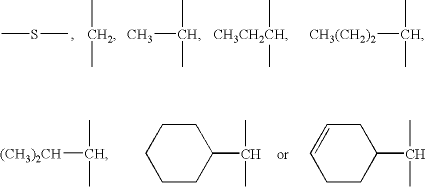

10. The composition according to claim 1 wherein phosphorous acid ester conforms structurally to the formula

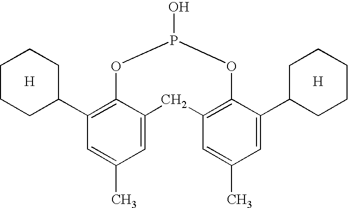

11. The composition according to claim 1 further containing at least one compound selected from the group consisting of:

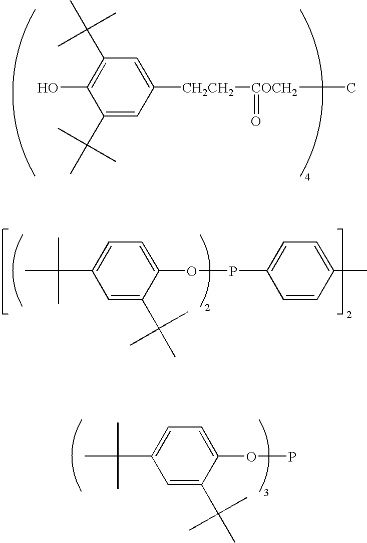

12. A molded article comprising the composition of claim 1.
